(19) United States
(12) Patent Application Publication
(10) Pub. No.: US 2021/0070178 A1
(43) Pub. Date: Mar. 11, 2021

(54) CAMERA-MONITOR SYSTEM FOR A MOTOR VEHICLE AND USE OF A MIRROR SUBSTITUTE SYSTEM FOR A MOTOR VEHICLE

(71) Applicant: Continental Automotive GmbH, Hannover (DE)

(72) Inventors: Andreas Weinlich, Schwalbach a. Ts. (DE); Thomas Garschke, Schwalbach a. Ts. (DE)

(73) Assignee: Continental Automotive GmbH, Hannover (DE)

(21) Appl. No.: 17/101,507

(22) Filed: Nov. 23, 2020

Related U.S. Application Data
(63) Continuation of application No. PCT/EP2019/062489, filed on May 15, 2019.

(30) Foreign Application Priority Data
May 29, 2018 (DE) 10 2018 208 513.7

(51) Int. Cl. B60K 37/02; B60R 11/04; B60K 35/00

(52) U.S. Cl. CPC B60K 37/02; B60R 11/04; B60K 35/00; B60K 2370/152; B60K 2370/589; B60K 2370/176; B60K 2370/21; B60K 2370/779; B60K 2370/155

(57) ABSTRACT

A camera-monitor system for a motor vehicle has a camera that is embodied to provide an image of an environment of the motor vehicle, and a monitor for representing images of the camera, said monitor having a telephony unit.

### CROSS-REFERENCE TO RELATED APPLICATIONS

This application claims priority to PCT Application PCT/EP2019/062489, filed May 15, 2019, which claims priority to German Patent Application No. DE 10 2018 208 513.7, filed May 29, 2018. The disclosures of the above applications are incorporated herein by reference.

### FIELD OF THE INVENTION

A camera-monitor system for a motor vehicle is specified, for example a camera-monitor system that is embodied as a mirror replacement system for the motor vehicle. The use of a mirror replacement system for a motor vehicle is also specified.

### BACKGROUND OF THE INVENTION

Motor vehicles may have a camera and a monitor that represents images of the camera fora user of the motor vehicle. For example, mirror replacement systems are known in which the fields of view of conventional exterior mirrors are imaged by the camera and the monitor.

It is desirable to specify a camera-monitor system for a motor vehicle that has an expanded field of application. In addition, it is desirable to specify the use of a mirror replacement system for a motor vehicle that permits additional fields of application.

### SUMMARY OF THE INVENTION

According to at least one embodiment, the camera-monitor system for the motor vehicle has a camera. The camera is embodied to provide an image of an environment of the motor vehicle. The camera-monitor system has a monitor for representing images of the camera. The monitor has a telephony unit.

The camera-monitor system is embodied as a mirror replacement system for the motor vehicle. In an embodiment, the camera-monitor system is embodied to represent images on the monitor while the motor vehicle is in motion. For example, it is possible, using the camera-monitor system, to represent the environment of the motor vehicle on the monitor of the camera-monitor system at least regionally for a driver and/or another user of the motor vehicle. Conventional exterior mirrors may thus be dispensed with, for example. The camera is assigned in an embodiment to a longitudinal side of the motor vehicle and is configured to image at least that part of the environment that may conventionally be viewed by a conventional exterior mirror. For example, the camera is arranged laterally with respect to the motor vehicle on a camera arm during operation.

The monitor has the telephony unit in addition to the elements for representing the images. The monitor is thus embodied to be used for telephone and/or videotelephone calls. In addition to the suitability for representing the images of the camera, the monitor, and thus the camera-monitor system, consequently has a telephone function. The monitor is mounted during operation for example to the A-pillar of the motor vehicle. In the case of trucks, for example, the monitor is mounted in the vicinity of the entrance handle of the motor vehicle, for example. In an embodiment, the monitor is attached in the immediate vicinity of the driver and/or front passenger. The monitor also protrudes for example into their frontal field of view. The monitor may be retrofitted in the motor vehicle, for example, without major modifications.

The telephony unit is in one embodiment fully or partially integrated into a housing of the monitor. The telephony unit is installed together with the display elements in the same housing of the monitor. The telephony unit may thus be easily integrated into the vehicle. In addition, the telephony unit may be attached in an advantageous vicinity of the driver and/or the front passenger. This makes possible, for example, good voice quality and/or good image quality. Additional integration of a microphone and/or cameras for telephone calls within the motor vehicle may be dispensed with. The telephony unit is installed in a single unit. This ensures a simple and cost-effective retrofitting capability.

According to at least one embodiment, the telephony unit has a microphone that is part of the monitor. The microphone may thus be attached close to the user. In this way, good recording quality is still possible in noisy outside conditions. Complicated post-working, for example for noise suppression, may be dispensed with.

According to at least one embodiment, the telephony unit has a further camera that is part of the monitor. The additional camera is directed for example at the user during operation and serves for transmitting a video signal for videotelephony. The camera is integrated in the monitor and therefore situated at a good angle to the user. This permits a frontal view of the user's face. The camera image of the user's face may thus be imaged without distortion. In this way, for example, recognition rates in driver assistance systems is improved in comparison to conventional interior cameras that may only record the user from very strong angles. The further camera also permits a natural depiction of the user through a frontal view of the user.

According to further embodiments, the telephony unit has a loudspeaker that is part of the monitor. The loudspeaker is used, for example, to output sound signals when making a telephone call. It is thus possible to fully integrate a self-sufficient telephony unit into the monitor of the camera-monitor system.

In the case of a videotelephony application, it is possible to represent the camera image of the other side on the monitor. This is done, for example, on the entire display surface of the monitor and/or only on a partial region. At least the legally required field of view class for exterior mirrors is displayed on the monitor during the journey. These are shown compressed, for example, to display space for the additional image of the video call. When the motor vehicle is stationary, it is possible to depict the image over the full area.

According to at least one embodiment, the system has a communication interface for data communication with an external cell phone. For example, the communication interface is part of the monitor, such as part of the telephony unit. It is thus possible, for example, to use data of the external cell phone during the telephone call by using the camera-monitor system, for example telephone numbers that are stored in the cell phone.

According to a further embodiment, the system has a transmission unit for transmitting audio information to a loudspeaker system of the motor vehicle. It is thus possible to transmit audio data of the telephony unit to the loudspeaker system of the motor vehicle and to reproduce them by use of the loudspeaker system of the motor vehicle. This allows integration of the camera-monitor system with the telephony function in already existing infotainment systems of the motor vehicle.

According to one embodiment, a mirror replacement system for a motor vehicle is used as a telephony system. The mirror replacement system has, in an embodiment, a camera-monitor system according to at least one embodiment of the invention. In addition to the conventional use of the mirror replacement system as a replacement for conventional exterior mirrors, the mirror replacement system may also be used as a telephony system. It is thus possible to use the mirror replacement system for telephone calls, for example for videotelephony and/or conventional telephony.

Further advantages, features, and developments are gathered from the following examples, which will be explained in connection with the figures. Identical elements or elements of the same type or with equivalent actions may be denoted by the same reference signs throughout the figures.

### BRIEF DESCRIPTION OF THE DRAWINGS

In the Figures:

FIG. 1 shows a schematic illustration of a motor vehicle with a camera-monitor system according to an exemplary embodiment, and

FIG. 2 shows a schematic illustration of a monitor according to an exemplary embodiment.

### DETAILED DESCRIPTION OF THE PREFERRED EMBODIMENTS

The following description of the preferred embodiment(s) is merely exemplary in nature and is in no way intended to limit the invention, its application, or uses.

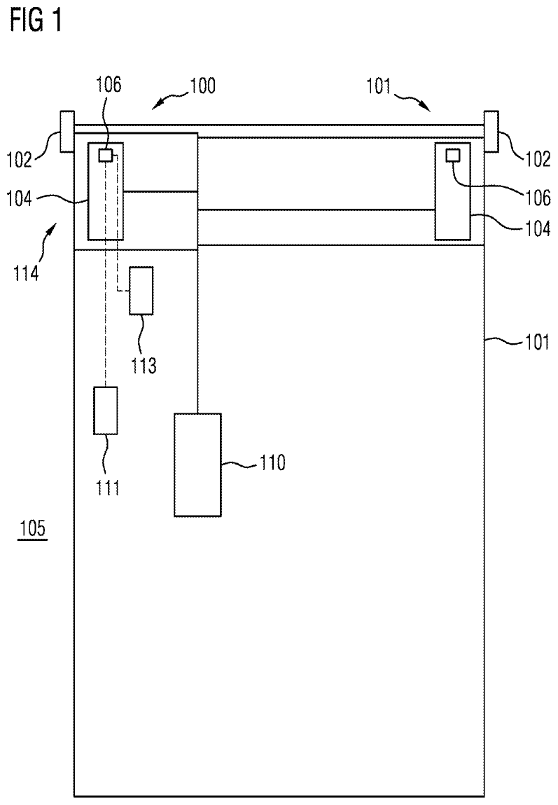

FIG. 1 shows a schematic illustration of a motor vehicle 101 according to one exemplary embodiment from above. The motor vehicle 101 is, for example, a truck. According to further exemplary embodiments, the motor vehicle is a bus and/or a passenger car.

The motor vehicle 101 has a camera-monitor system 100 as a mirror replacement system 114. The camera-monitor system 100 has one camera 102 per longitudinal side of the motor vehicle 101. The cameras 102 each serve to record part of an environment 105 of the motor vehicle 101. According to further exemplary embodiments, a plurality of cameras, for example two or more, are provided per longitudinal side. According to further exemplary embodiments, the camera 102 is provided only on one longitudinal side of the motor vehicle 101.

The camera 102 is embodied to record a part of the environment 105 that lies in the field of view of conventional exterior mirrors. For example, the camera 102 is arranged for this purpose on the longitudinal side on a camera arm laterally with respect to the motor vehicle 101.

The camera-monitor system 100 has two monitors 104. During operation, in each case a section of the associated environment 105 of the associated longitudinal side is represented on the monitors 104. In one example, the image of the associated camera 102 is represented on the monitor 104.

An apparatus 110 with which the cameras 102 and the monitors 104 are coupled for the transmission of signals is provided. The apparatus 110 is configured to control the cameras 102 and the monitors 104. By way of example, the apparatus 110 is a control device or part of a control device of the motor vehicle 101. In one embodiment, the apparatus 110 is configured for image processing.

The monitors 104 each have a telephony unit 106. According to further exemplary embodiments, not every monitor 104 has a telephony unit 106. For example, only one of the monitors 104 has the telephony unit 106. The telephony unit 106 allows the camera-monitor system 100 to be used for telephone calls, for example for transmitting audio signals by a cellular network and/or for transmitting videotelephony signals by a cellular network.

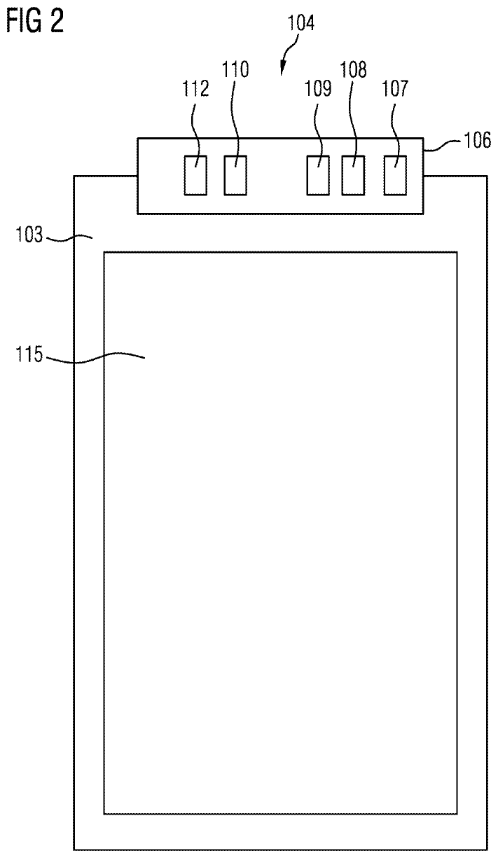

FIG. 2 shows a schematic illustration of the monitor 104 according to an exemplary embodiment. The monitor 104 has a housing 103. The monitor 104 has a display region 115. The display region 115 is used to display the images of the environment and/or to display images during use as a videotelephony system.

The housing 103 is the housing of the monitor 104, which also houses the elements for displaying the images in the display region 115. In one embodiment, the elements of the telephony unit 106 are also arranged in one and the same housing 103. The housing 103 carries and holds the elements of the telephony unit 106. The telephony unit 106 is integrated in the monitor 104.

The telephony unit 106 has a microphone 107. The microphone 107 is used to record sound signals, and in one embodiment, to record sound signals when making a telephone call and/or to record sound signals for voice control. The telephony unit 106 has a further camera 108. The further camera is used to record the driver of the motor vehicle 101 and/or to record a front passenger or another user of the motor vehicle 101 during videotelephony. The telephony unit 106 has a loud-speaker 109. The latter is used to output sound signals when making a telephone call.

The telephony unit 106 has a communication interface 110. The communication interface serves for connecting the telephony unit 106 and/or the camera-monitor system 100 to an external cell phone 111 (FIG. 1) for the transmission of signals. Data may thus be exchanged between the cell phone 111 and the telephony unit 106 for example using a wireless connection and/or using a wired connection. Such data include, for example, data such as telephone numbers or the like stored on the cell phone 111. According to exemplary embodiments, the connection of the cell phone 111 to the cellular network is used to connect the telephony unit 106 to the cellular network.

The telephony unit 106 has a transmission unit 112. The transmission unit 112 serves for connecting the telephony unit 106 to a loudspeaker system 113 (FIG. 1) of the motor vehicle 101 for the transmission of signals. Thus, the audio signals of the conversation partner may be output by the loudspeaker system 113 of the motor vehicle 101 when telephoning.

According to exemplary embodiments, the telephony unit 106 does not have all of the elements 107, 108, 109, 110, 112 shown in FIG. 2. According to exemplary embodiments, an arbitrary selection of the determining elements is implemented in the telephony unit 106.

The microphone 107 and/or the further camera 108 are installed in the same housing 103 together with the display elements of the mirror replacement system 114. The microphone 107 is placed as close as possible to the driver's mouth, and the further camera 108 allows the best possible frontal view onto the driver. This also applies correspondingly to the front passenger.

Either the loudspeaker system 113 of the motor vehicle 101 and/or the loudspeaker 109 of the monitor 104 is used for the sound reproduction. The use of the loudspeaker 109 of the monitor 107 is useful in conference systems.

The further camera 108 may be a conventional camera. According to exemplary embodiments, the further camera 108 is an HDR camera, an infrared camera, and/or a 3D camera. It is thus possible to use the images of the further camera 108 in addition to the videotelephony application also for other uses. For example, gaze direction recognition or further facial expression or gesture recognition is implemented by the further camera 108.

When used for videotelephony, it is possible to use the entire display region 115 to display the face of the other person. For legal reasons, this is only possible, for example, when the motor vehicle 101 is stationary. As an alternative or in addition, only a partial region of the display region 115 is used to represent the face of the other person. For example, the image of the camera 102 is shown strongly compressed in the display region 115 in order to meet legal requirements. Nevertheless, space has been created to additionally represent the image of the videotelephony in the display region 115. The legal regulations for the representation of the exterior mirror region are therefore not affected. Nevertheless, the face of the other person may be displayed. It is also possible that, for example while driving, the video signal of the telephony unit 106 is suppressed and the face of the other person is not represented in the display region 115 at all. Only the sound transmission, for example by the microphone 107 and the loudspeaker 109 and/or the loudspeaker system 113, is activated.

The cell phone 111 is integrated into the camera-monitor system 100 and the mirror replacement system 114 by the communication interface 110.

The camera-monitor system 100 permits good voice quality of the recorded voice when the camera-monitor system 100 is used for hands-free telephony applications. No additional microphones need to be installed in the roof region nor other elements of the motor vehicle 101. The further camera 108, which is integrated in the monitor 104, permits a frontal view of the driver's face when using the camera-monitor system 100 for videotelephony applications. This also permits a better recognition rate in driver assistance systems that require a camera image of the driver's face.

The monitor 104 may easily be retrofitted in existing vehicles because the microphone 107, the further camera 108, and the display region 115 are integrated in a single unit. In an embodiment, a computation unit, which may further process the signals of the individual elements, is also installed in the monitor 104.

The integration of the telephony unit 106 into the camera-monitor system 100 allows a lower dependency on other components and thus a cost efficiency and a reduction in the susceptibility to errors, when integrating into new vehicles. The telephony unit 106 may be integrated into the camera-monitor system 100 and, in an embodiment, into the mirror replacement system 114 at no more than low additional costs. According to exemplary embodiments, the camera image of the further camera 108 serves as an additional information source for an ADAS system (advanced driver assistance system). In the case of the mirror replacement system 114, this is also provided for images of the camera 102, for example. It is thus possible to use the images of the further camera 108, for example, without further components and/or without further cabling complexity.

The microphone 107 of the telephony unit 106 permits hands-free voice control of the motor vehicle 101. Gesture control of the motor vehicle 101 is possible by use of the further camera 108. The camera image of the driver's face of the further camera 108 may be used to support the ADAS system. The further camera 108 may be used as an additional source for observing the driver, for example during autonomous driving. A mobile office may be implemented for the front passenger in the motor vehicle 101, such as by use of a picture-in-picture concept on the display region 115, on which, for example, both the videotelephony image and the image of the mirror replacement system 114 may be represented.

The range of functions of the camera-monitor system 100 is thus expanded. The position of the monitor 104 is advantageously used in order to be able to record both an image and the voice of the user of the motor vehicle 101 with good quality and to be able to output the signals of the other side at well suited locations.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A camera-monitor system for a motor vehicle, comprising:
a camera that is embodied to provide an image of an environment of the motor vehicle;
a monitor for representing images of the camera, said monitor having a telephony unit.

2. The system of claim 1, the telephony unit further comprising a microphone that is part of the monitor.

3. The system of claim 1, the telephony unit further comprising a further camera that is part of the monitor.

4. The system of one of claim 1, the telephony unit further comprising a loudspeaker that is part of the monitor.

5. The system of one of claim 1, further comprising a communication interface for data communication with an external cell phone.

6. The system of one of claim 1, further comprising:
a loudspeaker system being part of the motor vehicle; and
a transmission unit for transmitting audio information to the loudspeaker system of the motor vehicle.

7. The system of one of claim 1, wherein the telephony unit is partially integrated into a housing of the monitor.

8. The system of one of claims 1, wherein the telephony unit is fully integrated into a housing of the monitor.

9. The system of one of claims 1, wherein the telephony unit is embodied for simultaneous image and sound transmission or for pure sound transmission.

10. The system of one of claim 1, wherein the camera monitor system is embodied as a mirror replacement system for the motor vehicle.

11. The system of claim 10, wherein the mirror replacement system for the motor vehicle is embodied as a telephony system.
